(19) United States
(12) Patent Application Publication
(10) Pub. No.: US 2026/0142276 A1
(43) Pub. Date: May 21, 2026

(54) THERMAL INSULATION PLATE FOR THERMALLY PROTECTING A PRISMATIC BATTERY CELL

(71) Applicant: GM GLOBAL TECHNOLOGY OPERATIONS LLC, Detroit, MI (US)

(72) Inventors: Matthew A. Celentano, Berkley, MI (US); Diptak Bhattacharya, Royal Oak, MI (US); Minghua Yang, Troy, MI (US); Varoon Shankar, Novi, MI (US); John C. Kalil, Washington, MI (US); Ryan P. Hickey, Austin, TX (US)

(73) Assignee: GM GLOBAL TECHNOLOGY OPERATIONS LLC, Detroit, MI (US)

(21) Appl. No.: 18/948,594

(22) Filed: Nov. 15, 2024

(51) Int. Cl. H01M 10/658; B60L 50/64; F16L 59/02; H01M 10/625; H01M 10/647; H01M 50/15; H01M 50/159; H01M 50/164; H01M 50/166; H01M 50/176; H01M 50/342; H01M 50/55

(52) U.S. Cl. CPC H01M 10/658; B60L 50/64; F16L 59/029; H01M 10/625; H01M 10/647; H01M 50/15; H01M 50/159; H01M 50/164; H01M 50/166; H01M 50/176; H01M 50/3425; H01M 50/55; H01M 2200/20; H01M 2220/20

(57) ABSTRACT

The present disclosure teaches a thermal insulation plate that has an outer plate with an thermal insulation layer that is encapsulated within the outer plate. A first pair of thru-holes and a first aperture pass through the thermal insulation plate. A separate cap plate is provided that has a second aperture co-aligned with the first aperture, and a matching second pair of thru-holes. The cap plate includes a burst membrane that covers the second aperture. The thermal insulation plate is inserted in-between the cap plate and the top of a prismatic battery cell, which provides thermal protection to adjacent battery cells. The thermally-protected battery cells may be used in an electric vehicle, hybrid vehicle, or other battery-powered device. The thermal insulation layer may be made of a carbon fiber reinforced plastic composite (CFRP), mica, steel, a ceramic material, or an intumescent coating on a metallic interlayer.

### INTRODUCTION

This disclosure relates to a thermal insulation plate that may be inserted in-between a cap plate and a prismatic battery cell for providing thermal protection to a prismatic battery cell.

Prismatic battery cells have an anode terminal and a cathode terminal located at opposite ends of a prismatic battery cell. The top of the prismatic battery cell may be covered with a cap plate that may have an aperture passing through the cap plate. The aperture may be covered with a burst membrane.

### SUMMARY

The present disclosure teaches a thermal insulation plate that has an outer plate with a thermal insulation layer that is encapsulated within the outer plate. A first pair of thru-holes and a first aperture pass through the thermal insulation plate. A separate cap plate is provided that has a second aperture co-aligned with the first aperture, and a matching second pair of thru-holes. The cap plate includes a burst membrane that covers the second aperture. The thermal insulation plate is inserted in-between the cap plate and the top of a prismatic battery cell, which provides thermal protection to adjacent battery cells. The thermally-protected battery cells may be used in an electric vehicle, hybrid vehicle, or other battery-powered device. The thermal insulation layer may be made of a carbon fiber reinforced plastic composite (CFRP), mica, steel, a ceramic material, or an intumescent coating on a metallic interlayer.

In a first embodiment, a thermal insulation plate includes: an outer plate, a thermal insulation layer that is encapsulated within the outer plate, a first thru-hole that is disposed through the thermal insulation layer and the outer plate, where the first thru-hole is configured to accept a first battery terminal, a second thru-hole that is disposed through the thermal insulation layer and the outer plate, where the second thru-hole is configured to accept a second battery terminal, and a thru-aperture that passes through the thermal insulation layer and the outer plate. The thru-aperture is configured to vent gases outwards from a battery cell in a controlled manner when a burst membrane on a cap plate covering a top of the battery cell has ruptured.

The thermal insulation layer may be made of a carbon fiber reinforced plastic composite (CFRP) material, mica, a steel alloy, a stainless-steel laminate, a ceramic material, an insulative material, an intumescent coating, and/or combinations thereof. An intumescent coating may be made of Al₂O₃, ZrO₂, TiC, SiC, Si₃N₄, a porous ceramic material, a two-layer coating consisting of a metallic bond coat and ceramic top-coat, and a steel alloy coated with an epoxy-based intumescent paint, and/or combinations thereof.

In another embodiment, a recessed air gap may be recessed into a top surface and/or a bottom surface of the thermal insulation plate. A thickness of the one or more recessed air gaps may range from about 25 microns to about 75 microns. The thru-aperture may have an elongated oval shape, and the thermal insulation plate may have a rectangular shape. The outer plate may be made of polyethylene.

In an embodiment, a cap plate includes a rectangular plate, a first aperture is recessed into at least one side of the rectangular plate where the first aperture has an opening in the rectangular plate, a burst membrane covering the opening in the rectangular plate, a first thru-hole disposed through the rectangular plate, where the first thru-hole is configured to accept a first battery terminal, and a second thru-hole disposed through the rectangular plate, where the second thru-hole is configured to accept a second battery terminal, and where the burst membrane covers the opening in the rectangular plate. The first aperture is configured to vent gases outwards from a battery cell in a controlled manner when the burst membrane is ruptured.

The cap plate may include a pair of extruded, inwardly-facing, L-shaped, attachment hooks disposed underneath the bottom surface of the cap plate. The first aperture may be a thru-aperture that passes completely through the rectangular plate. The rectangular plate may also have a plurality of parallel, uniformly spaced-apart strips located inside of the thru-aperture. These strips may be oriented perpendicular to a long direction of the rectangular plate. Alternatively, the plurality of parallel, uniformly spaced-apart strips may be oriented parallel to the long direction of the rectangular plate. Alternatively, a screen or mesh may be located inside of the thru-aperture.

In another embodiment, a thermal protection assembly includes a cap plate with a burst membrane and an underlying thermal insulation plate made of an outer plate and a thermal insulation layer that is encapsulated within the outer plate. A first thru-hole and a second thru-hole are located through both the cap plate and the thermal insulation plate, which are located at opposite ends of the thermal protection assembly. The assembly further includes a partially-recessed second aperture located underneath the burst membrane. The thermal insulation plate is inserted underneath the cap plate, and above a battery cell. The burst membrane may be made as an integral part of the rectangular plate and flush with a top surface of the rectangular plate, or the burst membrane may be attached to a top surface of the rectangular plate, where it covers the second aperture. Alternatively, the cap plate may include a pair of extruded, inwardly-facing, L-shaped, attachment hooks attached to the bottom surface of the rectangular plate. The thermal insulation plate may be inserted in-between, and held by, the pair of inwardly-facing, L-shaped, attachment hooks. The first aperture and the second aperture may be co-aligned with respect to each other.

In an embodiment, the rectangular plate of the thermal insulation plate may be a bi-metallic laminate that includes a top layer made of a first metal, and a bottom layer made of a second metal. The top layer is attached to the bottom layer, and the first metal may be different than the first metal.

In another embodiment, a battery cell includes: a prismatic battery cell with first terminal and a second terminal, located at opposite ends of the battery cell, and a cap plate covering the top of the battery cell. The cap plate includes a burst membrane covering a first aperture in the cap plate. A thermal insulation plate is inserted underneath the cap plate and above the battery cell. The thermal insulation plate includes an outer plate and a thermal insulation layer that is encapsulated within the outer plate. A first thru-hole and a second thru-hole may be positioned through both the cap plate and the thermal insulation plate and the pair of thru-holes may be located at opposite ends of the prismatic battery cell. The first battery terminal and the second battery terminal are coaxially-aligned with the first thru-hole and the second thru-hole, respectively.

In another embodiment, a first aperture in the cap plate and a second aperture in the thermal insulation plate are co-aligned with respect to each other.

In a related embodiment, the battery cell may include an anode rivet positioned through both the anode terminal and the first thru-hole; and a cathode rivet positioned through both the cathode terminal and the second thru-hole. The anode rivet and the cathode rivet may be configured to attach the thermal insulation plate and the cap plate to the battery cell.

In an embodiment, a cap plate covers a prismatic battery cell, and a thermal insulation plate is disposed in-between the cap plate and the prismatic battery cell.

In another embodiment, a vehicle includes: (a) a vehicle body, (b) at least one wheel attached to the vehicle body, (c) at least one electric traction drive motor configured to drive the at least one wheel, (d) a prismatic battery cell, which is electrically connected to the at least one electric traction drive motor, which has a first terminal located at a proximal end of the prismatic battery cell and a second terminal located at a distal end of the prismatic battery cell, (e) a cap plate located above the battery cell, and (f) a thermal insulation plate located underneath the cap plate and above the battery cell. The cap plate may include: a rectangular plate, a first aperture passing through at least one side of the rectangular plate, a burst membrane covering one side of the first aperture, a first thru-hole located through the rectangular plate at a proximal end of the cap plate; and a second thru-hole located through the rectangular plate at a distal end of the cap plate. The thermal insulation plate may include an outer plate and a thermal insulation layer that is encapsulated within the outer plate. A third thru-hole passes through the thermal insulation layer and the outer plate at a proximal end of the thermal insulation plate, and a fourth thru-hole passes through the thermal insulation layer and the outer plate at a distal end of the thermal insulation plate. A second aperture passes through the thermal insulation layer and the outer plate. The first thru-hole and the third thru-hole coaxially align with the first terminal, and the second thru-hole and the fourth thru-hole coaxially align with the second terminal. Also, the first aperture and the second aperture coaxially align with respect to each other.

In another embodiment, the vehicle may further include: (a) a first rivet passing through: (1) the first terminal, (2) the first thru-hole; and (3) the third thru-hole; and (b) a second rivet passing through: (4) the second terminal, (5) the second thru-hole; and (6) the fourth thru-hole. The first rivet and the second rivet are configured to attach the thermal insulation plate and the cap plate to a battery cell.

### BRIEF DESCRIPTION OF THE DRAWINGS

FIG. 1A shows a plan view of an example of a cap plate for use with a battery cell enclosure.

FIG. 1B shows an elevation, side cross-section view (Sec. A-A) of an example of a cap plate for use with a battery cell enclosure.

FIG. 1C shows an elevation, side cross-section view (Sec. A-A) of an example of a cap plate for use with a battery cell enclosure.

FIG. 2A shows a plan view of an example of a cap plate for use with a battery cell enclosure.

FIG. 2B shows an elevation, side cross-section view (Sec. B-B) of an example of a cap plate for use with a battery cell enclosure.

FIG. 2C shows an elevation, side cross-section view (Sec. B-B) of an example of a cap plate for use with a battery cell enclosure

FIG. 3A shows a plan view of an example of a thermal insulation plate for use with a battery cell enclosure.

FIG. 3B shows an elevation, side cross-section view (Sec. C-C) of an example of a thermal insulation plate for use with a battery cell enclosure.

FIG. 3C shows an elevation, side cross-section view (Sec. C-C) of an example of a thermal insulation plate for use with a battery cell enclosure.

FIG. 3D shows an elevation, side cross-section view (Sec. C-C) of an example of a thermal insulation plate for use with a battery cell enclosure.

FIG. 4A shows a plan view of an example of an assembly comprising a thermal insulation layer disposed underneath a cap plate for use with a battery cell enclosure.

FIG. 4B shows an elevation, side cross-section view (Sec. D-D) of an example of an assembly comprising a thermal insulation plate disposed underneath a cap plate for use with a battery cell enclosure.

FIG. 4C shows an elevation, side cross-section view (Sec. D-D) of an example of an assembly comprising a thermal insulation plate disposed underneath a cap plate for use with a battery cell enclosure.

FIG. 5A shows a plan view of an example of a cap plate for use with a battery cell enclosure.

FIG. 5B shows an elevation, side cross-section view (Sec. E-E) of an example of a cap plate for use with a battery cell enclosure.

FIG. 6A shows a plan view of an example of an assembly comprising a thermal insulation plate disposed underneath a cap plate for use with a battery cell enclosure.

FIG. 6B shows an elevation, side cross-section view (Sec. F-F) of an example of an assembly comprising a thermal insulation plate disposed underneath a cap plate for use with a battery cell enclosure.

FIG. 7A shows a plan view of an example of an assembly comprising a thermal insulation layer disposed underneath a cap plate for use with a battery cell enclosure.

FIG. 7B shows an elevation, side cross-section view (Sec. G-G) of an example of an assembly comprising a thermal insulation plate disposed underneath a cap plate for use with a battery cell enclosure.

FIG. 8A shows a plan view of an example of a perforated cap plate for use with a battery cell enclosure.

FIG. 8B shows an elevation, side cross-section view (Sec. H-H) of an example of a perforated cap plate for use with a battery cell enclosure.

FIG. 9A shows a plan view of an example of a perforated cap plate for use with a battery cell enclosure.

FIG. 9B shows an elevation, side cross-section view (Sec. I-I) of an example of a perforated cap plate for use with a battery cell enclosure.

FIG. 10A shows a plan view of an example of an assembly comprising a cap plate disposed on top of a battery cell.

FIG. 10B shows an elevation, side cross-section view (Sec. J-J) of an example of an assembly comprising a cap plate disposed on top of a battery cell.

FIG. 11A shows a plan view of an example of an assembly comprising a rectangular cap plate disposed above a thermal insulation plate that is disposed on top of a battery cell.

FIG. 11B shows an elevation, side cross-section view (Sec. K-K) of an example of an assembly comprising a rectangular cap plate disposed above a thermal insulation plate that is disposed on top of a battery cell.

FIG. 12A shows a plan view of an example of a combined thermal protection plate for use with a battery cell.

FIG. 12B shows an elevation, side cross-section view (Sec. L-L) of an example of a combined thermal protection plate for use with a battery cell.

FIG. 13 shows a perspective view of an example of an automobile with a battery tray containing a battery cell.

### DETAILED DESCRIPTION OF THE DISCLOSURE

As used herein, the term “battery enclosure” and “battery can” are used interchangeably. The drawings are not drawn to scale. The phrase “thru-aperture” means that an aperture or hole in a plate reaches (i.e., traverses) completely across and passes through the entire thickness of the plate from one surface to an opposing surface of the plate. The phrase “partially-recessed aperture” means that an aperture or hole in a plate does not reach completely across the entire thickness of the plate from one surface to an opposing surface of the plate, but, rather, only passes through a single side of the plate (but not both). The term “about” means +/−5% of the cited value. The word “vehicle”, as it is used herein, is broadly defined to include, but is not limited to, battery-powered objects, devices, or structures (which may be moving or stationary) that include, for example: automobiles, electric automobiles, hybrid automobiles, motorcycles, bicycles, trains, ships, boats, jet skis, scooters, tractors, snow blowers, mowers, airplanes, drones, spacecraft, submarines, satellites, earth-moving machinery, and solar energy storage batteries. The word “prismatic” broadly includes rectangular, square, and cubical shaped geometries and volumes.

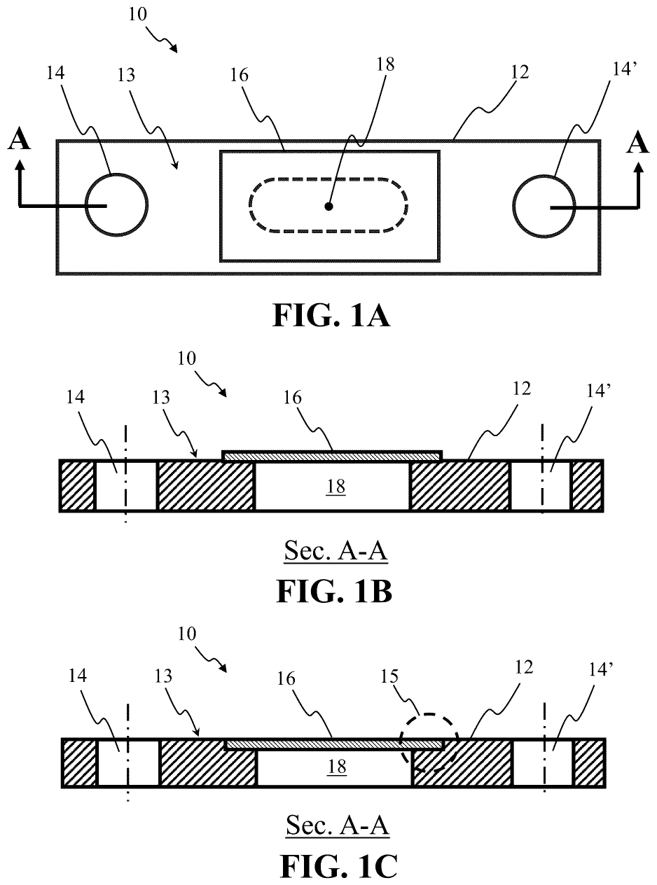

FIG. 1A shows a plan view of an example of a cap plate 10 for use with a battery cell enclosure (not shown). Cap plate 10 comprises a rectangular plate 12 with a pair of thru-holes 14 and 14′ disposed at opposite ends of rectangular plate 12. Rectangular plate 12 defines a thru-aperture 18 that is disposed through rectangular plate 12, connecting top surface 13 to bottom surface 11. Thru-aperture 18 may have an elongated oval shape. A thin, burst membrane 16 may be disposed on top of thru-aperture 18. Burst membrane 16 is attached to top surface 13 of rectangular plate 12, where membrane 16 covers and seals one side of thru-aperture 18.

FIG. 1B shows an elevation, side cross-section view (Sec. A-A) of an example of a cap plate 10 for use with a battery cell enclosure (not shown). Cap plate 10 comprises a rectangular plate 12 with a pair of thru-holes 14 and 14′ disposed at opposite ends of rectangular plate 12. Thru-aperture 18 passes through the thickness of rectangular plate 12. Thru-aperture 18 may have an elongated, oval shape. A thin, burst membrane 16 is disposed on top of thru-aperture 18. Burst membrane 16 is attached to top surface 13 of rectangular plate 12, where membrane 16 covers and seals one side of thru-aperture 18. Cap plate 10 may be made of aluminum or an aluminum alloy. Thru-aperture 18 passes through the thickness of rectangular plate 12.

FIG. 1C shows an elevation, side cross-section view (Sec. A-A) of an example of a cap plate 10 for use with a battery cell enclosure (not shown). Cap plate 10 comprises a rectangular plate 12 with a pair of thru-holes 14 and 14′ disposed at opposite ends of rectangular plate 12. Thru-aperture 18 passes through the thickness of rectangular plate 12. Thru-aperture 18 may have an elongated, oval shape. A thin, burst membrane 16 is disposed on top of thru-aperture 18. Burst membrane 16 is attached to top surface 13 of rectangular plate 12, where membrane 16 covers and seals thru-aperture 18. In this embodiment, burst membrane 16 is attached inside of recessed groove 15 that has been fabricated into top surface 13 of rectangular plate 12. In this configuration, burst membrane 16 is flush with top surface 13 of rectangular plate 12.

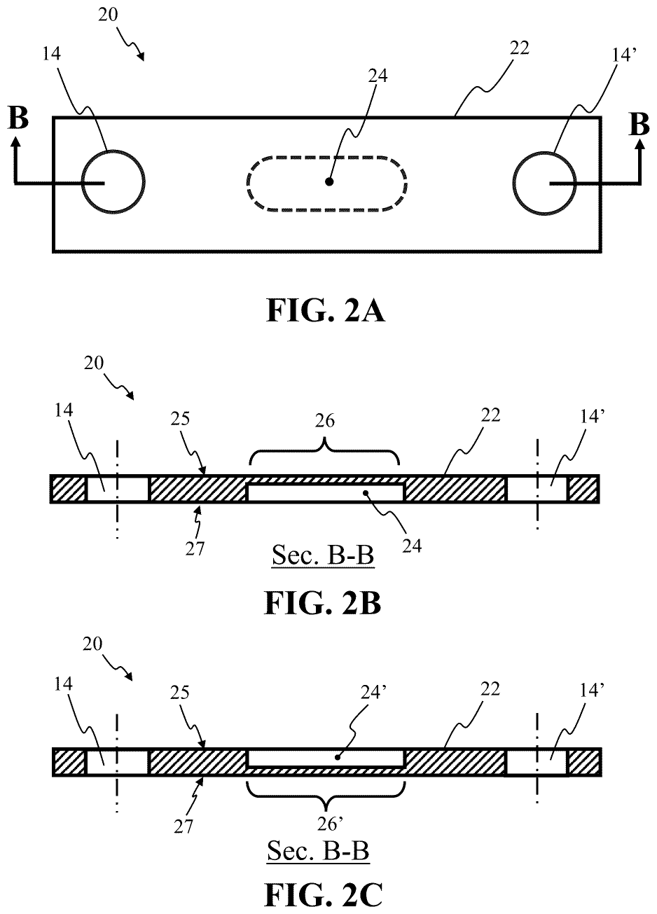

FIG. 2A shows a plan view of an example of a cap plate 20 for use with a battery cell enclosure (not shown). Cap plate 20 comprises a rectangular plate 22 with a pair of thru-holes 14 and 14′ disposed at opposite ends of rectangular plate 22. Rectangular plate 22 defines a partially-recessed aperture 24, which may have an elongated, oval shape.

FIG. 2B shows an elevation, side cross-section view (Sec. B-B) of an example of a cap plate 20 for use with a battery cell enclosure (not shown). Cap plate 20 comprises a rectangular plate 22 with a pair of thru-holes 14 and 14′ disposed at opposite ends of rectangular plate 22. Rectangular plate 22 defines a partially-recessed aperture 24 that may be disposed partially upwards into a bottom surface 27 of rectangular plate 22. Partially-recessed aperture 24 may have an elongated, oval shape. A thin, burst membrane layer 26 is made integrally with, and is flush with, top surface 25 of rectangular plate 22. Burst membrane layer 26 seals partially-recessed aperture 24.

FIG. 2C shows an elevation, side cross-section view (Sec. B-B) of an example of a cap plate 20 for use with a battery cell enclosure (not shown). Cap plate 20 comprises a rectangular plate 22 with a pair of thru-holes 14 and 14′ disposed at opposite ends of rectangular plate 22. Rectangular plate 22 defines a partially-recessed aperture 24′ that may be inserted partially downwards into a top surface 25 of rectangular plate 22. Partially-recessed aperture 24′ may have an elongated, oval shape. A thin, burst membrane layer 26′ is made integrally with, and is flush with, bottom surface 27 of rectangular plate 22. Burst membrane layer 26′ seals partially-recessed aperture 24′.

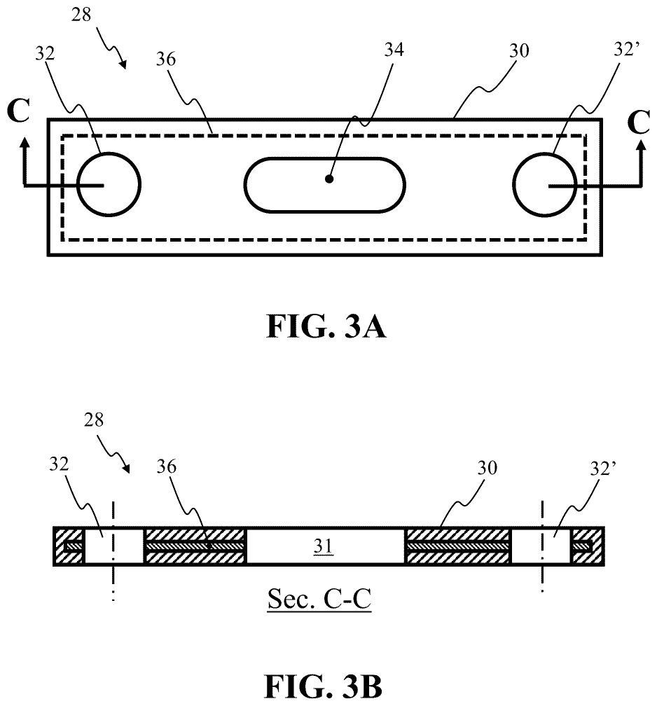

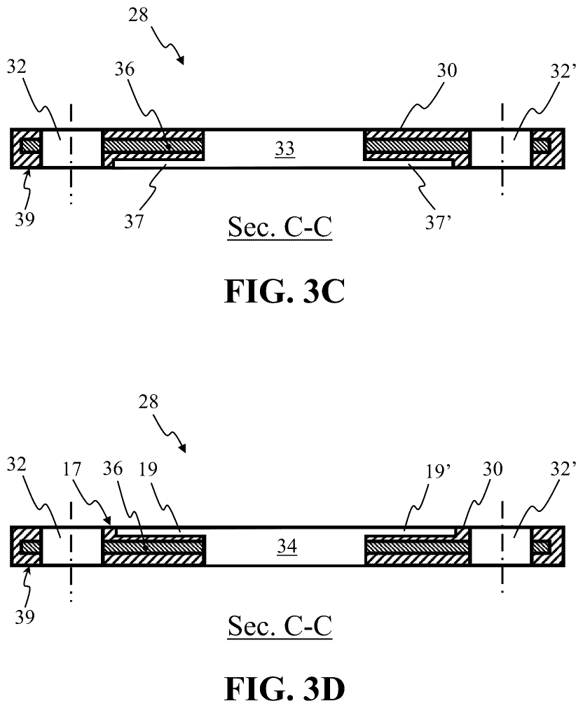

FIG. 3A shows a plan view of an example of a thermal insulation plate 28 for use with a battery cell enclosure (not shown). Thermal insulation plate 28 comprises a rectangular plate 30 with a pair of thru-holes 32 and 32′ disposed at opposite ends of rectangular plate 30. Rectangular plate 30 defines a thru-aperture 34, which may have an elongated, oval shape. Thermal insulation layer 36 is disposed inside of, and is encapsulated by, rectangular plate 30.

FIG. 3B shows an elevation, side cross-section view (Sec. C-C) of an example of a thermal insulation plate 28 for use with a battery cell enclosure (not shown). Thermal insulation plate 28 comprises a rectangular outer plate 30 with a pair of thru-holes 32 and 32′ disposed at opposite ends of rectangular outer plate 30. Rectangular outer plate 30 defines a thru-aperture 31, which may have an elongated, oval shape. Thermal insulation layer 36 is disposed inside of, and is encapsulated by, rectangular outer plate 30. Thermal insulation layer 36 may be made of a carbon fiber reinforced plastic composite (CFRP) material, mica, a steel alloy, a stainless-steel laminate, a ceramic material, an insulative material, an intumescent coating, and/or combinations thereof. An intumescent coating may be a ceramic, such as: Al₂O₃, ZrO₂, TiC, SiC, Si₃N₄; a porous ceramic material having a porosity of at least 10% by volume; a two-layer coating consisting of a metallic bond coat and ceramic top-coat; and steel coated with an epoxy-based intumescent paint, and/or combinations thereof. Thermal insulation plate 28 may be made by a one-step or two-step injection molding process, 3-D printing, etc. In this embodiment, thermal insulation plate 28 does not have a burst membrane.

FIG. 3C shows an elevation, side cross-section view (Sec. C-C) of an example of a thermal insulation plate 28 for use with a battery cell enclosure (not shown). Thermal insulation plate 28 comprises a rectangular outer plate 30 with a pair of thru-holes 32 and 32′ disposed at opposite ends of rectangular outer plate 30. Rectangular outer plate 30 defines a thru-aperture 33, which may have an elongated, oval shape. Thermal insulation layer 36 is disposed inside of, and is encapsulated by, rectangular outer plate 30. Thermal insulation plate 28 may be made by injection molding, 3-D printing, etc. In this embodiment, thermal insulation plate 28 does not have a burst membrane layer. Furthermore, thermal insulation plate 28 may comprise a recessed air gap 37 and 37′ recessed into a bottom surface 39 of rectangular outer plate 30, for providing additional thermal insulation. The thickness of recessed air gap 37 and 37′ may range from about 25 microns to about 75 microns. Alternatively, recessed air gap 37 and 37′ may be about 50 microns thick.

FIG. 3D shows an elevation, side cross-section view (Sec. C-C) of an example of a thermal insulation plate 28 for use with a battery cell enclosure (not shown). Thermal insulation plate 28 comprises a rectangular outer plate 30 with a pair of thru-holes 32 and 32′ disposed at opposite ends of rectangular outer plate 30. Rectangular outer plate 30 defines a thru-aperture 34, which may have an elongated, oval shape. Thermal insulation layer 36 is disposed inside of, and is encapsulated by, rectangular outer plate 30. Furthermore, thermal insulation plate 28 may comprise a recessed air gap 19 and 19′ recessed into a top surface 17 of rectangular outer plate 30, for providing additional thermal insulation. The thickness of recessed air gap 19 and 19′ may range from about 25 microns to about 75 microns. Alternatively, recessed gap 19 and 19′ may be about 50 microns thick.

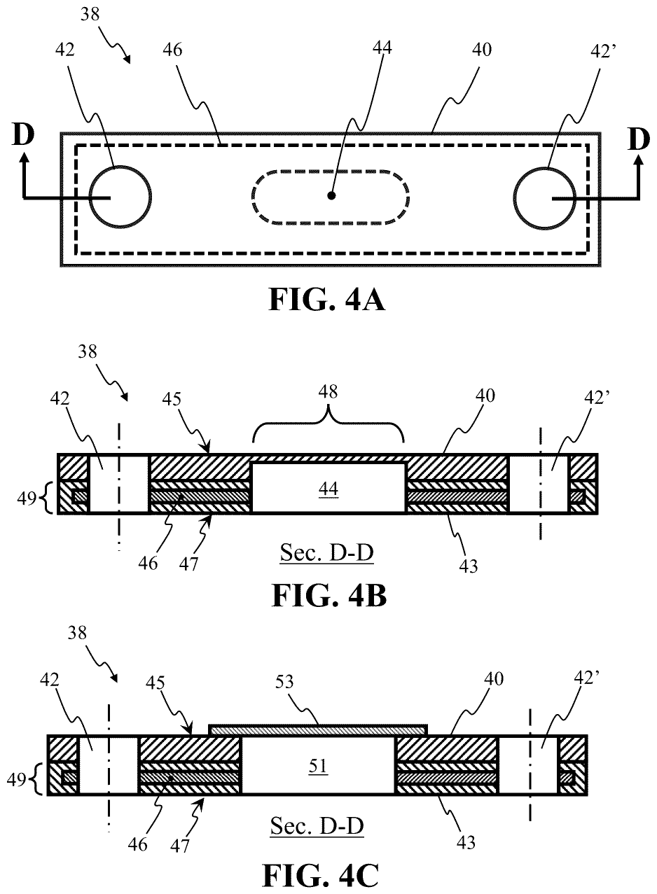

FIG. 4A shows a plan view of an example of an assembly 38 comprising a thermal insulation layer 46 disposed underneath a rectangular cap plate 40 for use with a battery cell enclosure (not shown). Assembly 38 comprises a pair of thru-holes 42 and 42′ disposed at opposite ends of assembly 38. Rectangular plate 40 defines a partially-recessed aperture 44, which may have an elongated, oval shape. Thermal insulation layer 46 is disposed underneath rectangular cap plate 40.

FIG. 4B shows an elevation, side cross-section view (Sec. D-D) of an example of an assembly 38 comprising a thermal insulation plate 49 disposed underneath rectangular cap plate 40 for use with a battery cell enclosure (not shown). Assembly 38 comprises a pair of thru-holes 42 and 42′ that are disposed at opposite ends of assembly 38. Rectangular cap plate 40 defines a partially-recessed aperture 44, which may have an elongated, oval shape. Partially-recessed aperture 44 is inserted upwards into a bottom surface 47 of rectangular outer plate 43. A thin, burst membrane layer 48 is made integrally with, and is flush with, top surface 45 of rectangular cap plate 40. Burst membrane layer 48 seals partially-recessed aperture 44. Thermal insulation plate 49 comprises a “sandwich” construction comprising an inner thermal insulation layer 46 that is disposed inside of, and is encapsulated by, rectangular outer plate 43. Partially-recessed aperture 44 is disposed through thermal insulation plate 49 and then partially-recessed into rectangular cap plate 40, thereby defining integral burst membrane layer 48.

FIG. 4C shows an elevation, side cross-section view (Sec. D-D) of an example of an assembly 38 comprising a thermal insulation plate 49 disposed underneath rectangular cap plate 40 for use with a battery cell enclosure (not shown). Assembly 38 comprises a pair of thru-holes 42 and 42′ that are disposed at opposite ends of assembly 38. Rectangular cap plate 40 defines a partially-recessed aperture 44, which may have an elongated, oval shape. Thru-aperture 51 passes through assembly 38. A thin, burst membrane 53 is attached to top surface 45 of rectangular cap plate 40, where it seals thru-aperture 51. Burst membrane 53 is not flush with the top surface 45 of rectangular plate 40. Thermal insulation plate 49 comprises a “sandwich” construction comprising an inner thermal insulation layer 46 that is disposed inside of, and is encapsulated by, rectangular outer plate 43. Thru-aperture 51 passes upwards through thermal insulation plate 49 and through rectangular cap plate 40.

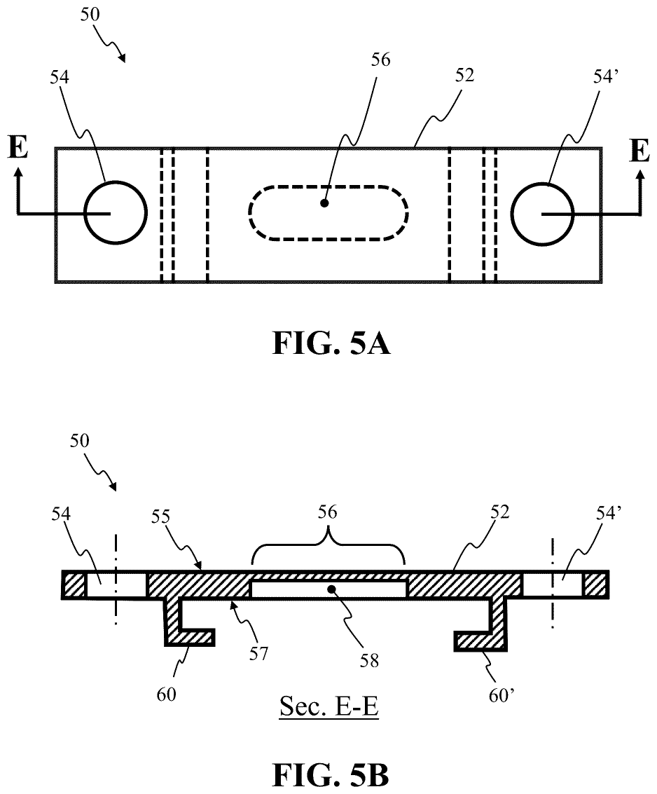

FIG. 5A shows a plan view of an example of a cap plate 50 for use with a battery cell enclosure (not shown). Cap plate 50 comprises a rectangular plate 52 with a pair of thru-holes 54 and 54′ disposed at opposite ends of rectangular plate 52. Rectangular plate 52 defines a recessed aperture 58, which may have an elongated, oval shape.

FIG. 5B shows an elevation, side cross-section view (Sec. E-E) of an example of a cap plate 50 for use with a battery cell enclosure (not shown). Cap plate 50 comprises a rectangular plate 52 with a pair of thru-holes 54 and 54′ disposed at opposite ends of rectangular plate 52. Rectangular plate 52 defines a partially-recessed aperture 58 that may be disposed partially upwards into a bottom surface 57 of rectangular plate 52. Partially-recessed aperture 58 may have an elongated, oval shape. A thin, burst membrane layer 56 is made integrally with, and is flush with, top surface 55 of rectangular plate 52. Burst membrane layer 56 seals partially-recessed aperture 58. Cap plate 50 may be made of aluminum or an aluminum alloy. A pair of inwardly-facing, L-shaped, attachment hooks 60 and 60′ are disposed facing each other, protruding downwards from the bottom surface 57 of rectangular plate 52. In this embodiment, L-shaped, attachment hooks 60 and 60′ are extruded, or 3-D printed, integrally with rectangular plate 52. Alternatively, in other embodiments, L-shaped, attachment hooks 60 and 60′ may be separately attached (e.g., brazed or welded) to the bottom surface 57 of rectangular plate 52.

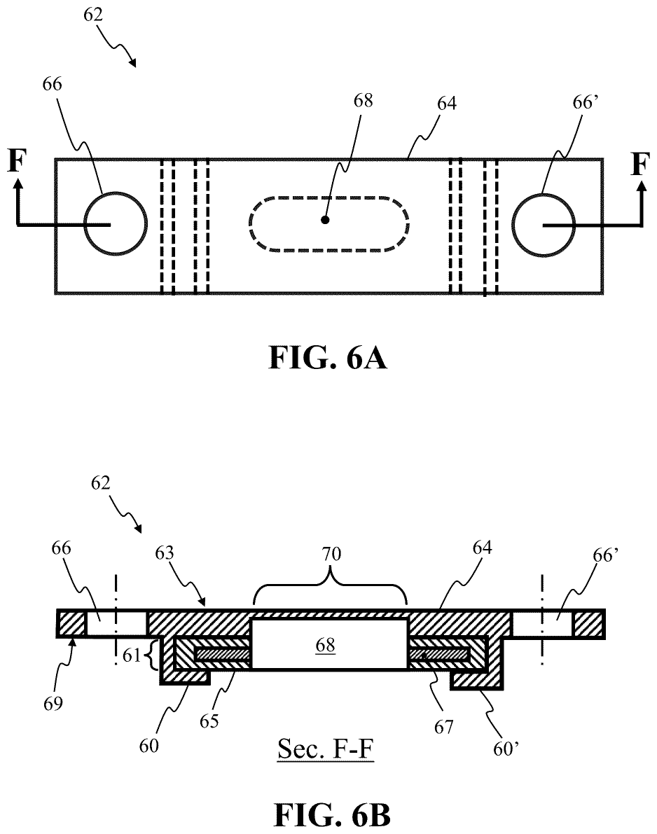

FIG. 6A shows a plan view of an example of an assembly 62 comprising a thermal insulation plate 61 (not seen in this view) disposed underneath a rectangular cap plate 64 for use with a battery cell enclosure (not shown). Assembly 62 comprises a rectangular cap plate 64 with a pair of thru-holes 66 and 66′ disposed at opposite ends of rectangular cap plate 64. Rectangular cap plate 64 defines a partially-recessed aperture 68, which may have an elongated, oval shape.

FIG. 6B shows an elevation, side cross-section view (Sec. F-F) of an example of an assembly 62 comprising a thermal insulation plate 61 disposed underneath a rectangular cap plate 64 for use with a battery cell enclosure (not shown). Assembly 62 comprises a rectangular cap plate 64 with a pair of thru-holes 66 and 66′ disposed at opposite ends of rectangular cap plate 64. Rectangular cap plate 64 defines a partially-recessed aperture 68, which may have an elongated, oval shape. A thin, burst membrane layer 70 is made integrally with, and is flush with, top surface 63 of rectangular cap plate 64. Burst membrane layer 70 seals partially-recessed aperture 68. A pair of inwardly-facing, L-shaped, attachment hooks 60 and 60′ are disposed facing each other, protruding downwards from the bottom surface 69 of rectangular cap plate 64. In this embodiment, L-shaped, attachment hooks 60 and 60′ are extruded, or 3-D printed, integrally along with rectangular cap plate 64. Alternatively, in other embodiments, L-shaped, attachment hooks 60 and 60′ may be separately attached (e.g., brazed or welded) to the bottom surface 69 of rectangular cap plate 64. Thermal insulation plate 61 comprises a “sandwich” construction comprising an inner thermal insulation layer 67 that is disposed inside of, and is encapsulated by, rectangular outer plate 65. Partially-recessed aperture 68 is disposed through thermal insulation plate 61 and is partially-recessed into rectangular cap plate 64, thereby defining integral burst membrane layer 70. L-shaped, attachment hooks 60 and 60′ cooperate to securely hold thermal insulation plate 61 up against rectangular cap plate 64.

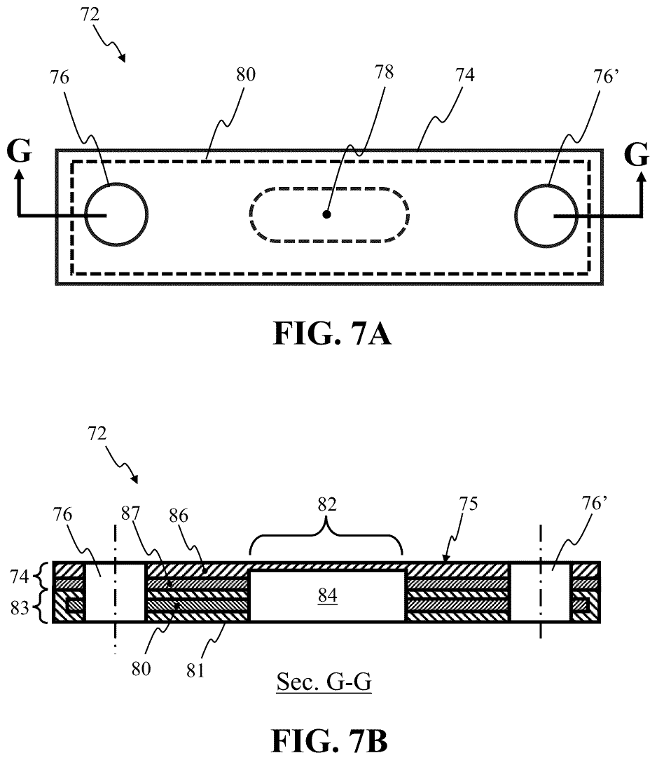

FIG. 7A shows a plan view of an example of an assembly 72 comprising a thermal insulation layer 80 disposed underneath a cap plate 74 for use with a battery cell enclosure (not shown). Assembly 72 comprises a pair of thru-holes 76 and 76′ disposed at opposite ends of assembly 72. Rectangular cap plate 74 defines a partially-recessed aperture 78, which may have an elongated, oval shape. Thermal insulation layer 80 is disposed underneath rectangular cap plate 74.

FIG. 7B shows an elevation, side cross-section view (Sec. G-G) of an example of an assembly 72 comprising a thermal insulation plate 83 disposed underneath a cap plate 74 for use with a battery cell enclosure (not shown). Assembly 72 comprises a rectangular cap plate 74 with a pair of thru-holes 76 and 76′ disposed at opposite ends of rectangular cap plate 74. Rectangular cap plate 74 defines a partially-recessed aperture 84, which may have an elongated, oval shape. A thin, burst membrane layer 82 is made integrally with, and is flush with, top surface 75 of rectangular cap plate 74. Burst membrane layer 82 seals partially-recessed aperture 84. Rectangular cap plate 74 comprises a bi-metallic laminate construction comprising a top layer 86 made of a first metal that is bonded to a bottom layer 87 made of a second metal; wherein the first metal is different from the second metal. The top layer 86 may comprise aluminum or aluminum alloy, and the bottom layer 87 may comprise a steel alloy. The top and bottom layers 86 and 87, respectively, may be roll-bonded or explosion-bonded together to make a bi-metallic laminate cap plate 74. Thermal insulation plate 83 comprises a “sandwich” configuration comprising an inner thermal insulation layer 80 that is disposed inside of, and is encapsulated by, rectangular outer plate 81. Partially-recessed aperture 84 is disposed through thermal insulation plate 83, then disposed through bottom layer 87, and then is partially-recessed into top layer 86, thereby defining integral burst membrane layer 82.

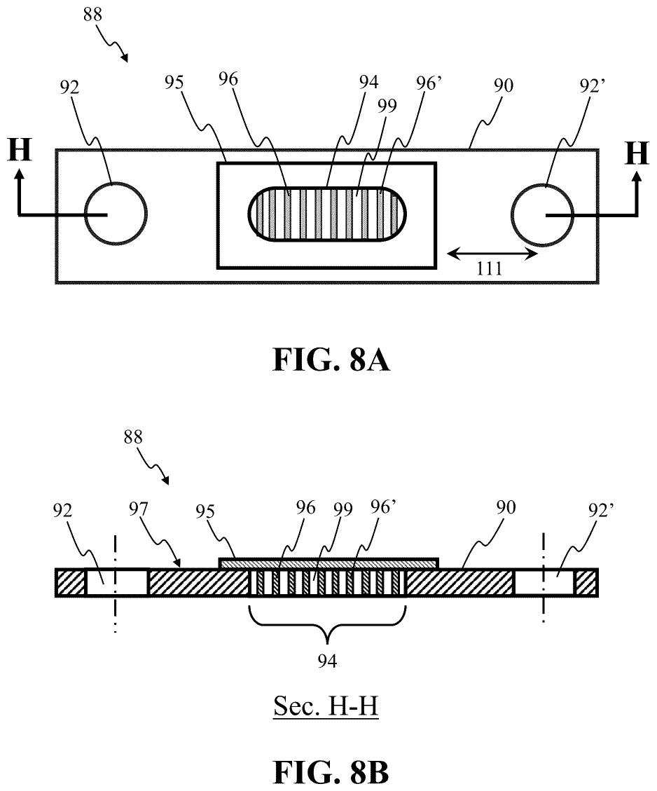

FIG. 8A shows a plan view of an example of a perforated cap plate 88 for use with a battery cell enclosure (not shown). Perforated cap plate 88 comprises a rectangular plate 90 comprising a pair of thru-holes 92 and 92′ disposed at opposite ends of rectangular plate 90. Rectangular plate 90 defines thru-aperture 94, which may have an elongated, oval shape. A plurality of uniformly spaced-apart, parallel transverse strips 96, 96′, etc. are disposed inside of thru-aperture 94 and are oriented perpendicular to the long direction 111 of rectangular cap plate 90. A uniform spacing 99 between adjacent parallel transverse strips 96, 96′, etc. may range from about 1 mm to about 3 mm wide; or, alternatively, spacing 99 may be about 2 mm wide. Such a perforated, filter-like, array of parallel transverse strips 96, 96′, etc. permits high pressure gas (not shown) to be expelled upwards through thru-aperture 94 when burst membrane 95 (see FIG. 8B) has ruptured, while also preventing (i.e., filtering out) solid particles (not shown) from passing through the array of parallel transverse strips 96, 96', etc. in one of two different directions (either entering into the battery cell or exiting out from the battery cell (not shown)). Note: thin, burst membrane 95 is not illustrated in this view for enhanced clarity (see FIG. 8B).

FIG. 8B shows an elevation, side cross-section view (Sec. H-H) of an example of a perforated cap plate 88 for use with a battery cell enclosure (not shown). Perforated cap plate 88 comprises a rectangular plate 90 comprising a pair of thru-holes 92 and 92′ disposed at opposite ends of rectangular plate 90. Rectangular cap plate 90 defines thru-aperture 94, which may have an elongated, oval shape. A plurality of uniformly spaced-apart, parallel transverse slots 96, 96′, etc. are disposed inside of thru-aperture 94 and are oriented perpendicular to the long direction 111 of rectangular plate 90. A uniform spacing 99 between adjacent parallel transverse slots 96, 96′, etc. may range from about 1 mm to about 3 mm, or, alternatively, may be equal to about 2 mm. Thin, burst membrane 95 is attached to top surface 97 of rectangular cap plate 90 and covers and seals thru-aperture 94.

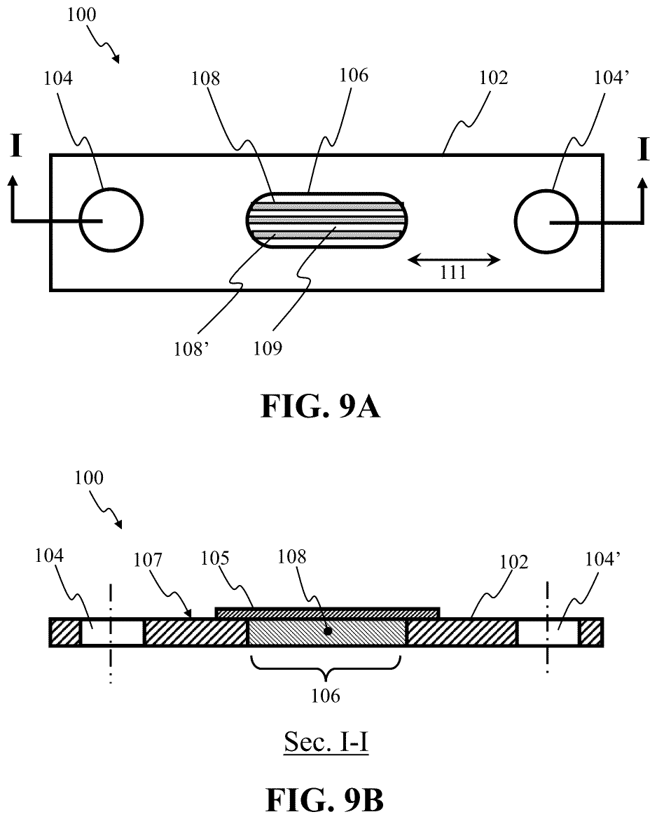

FIG. 9A shows a plan view of an example of a perforated cap plate 100 for use with a battery cell enclosure (not shown). Perforated cap plate 100 comprises rectangular plate 102 comprising a pair of thru-holes 104 and 104′ disposed at opposite ends of rectangular plate 102. Rectangular plate 102 defines thru-aperture 106, which may have an elongated, oval shape. A plurality of uniformly spaced-apart, parallel longitudinal strips 108, 108′, etc. are disposed inside of thru-aperture 106 and are oriented parallel to the long direction 111 of rectangular plate 102. A uniform spacing 109 between adjacent parallel longitudinal strips 108, 108', etc. may range from about 1 mm to about 3 mm wide; or, alternatively spacing 109 may be equal to about 2 mm wide. Such a perforated, filter-like array of parallel longitudinal strips 108, 108′, etc. permits gas (not shown) to be expelled though thru-aperture 106, while preventing (i.e., filtering out) solid particles (not shown) from passing through longitudinal strips 108, 108', etc. in one of two different directions (i.e., either entering into the battery cell or exiting out of the battery cell (not shown)). Note: thin, burst membrane 95 is not illustrated in this view for enhanced clarity (see FIG. 9B).

FIG. 9B shows an elevation, side cross-section view (Sec. I-I) of an example of a perforated cap plate 100 for use with a battery cell enclosure (not shown). Perforated cap plate 100 comprises a rectangular plate 102 comprising a pair of thru-holes 104 and 104′ disposed at opposite ends of rectangular plate 102. Rectangular plate 102 defines thru-aperture 106, which may have an elongated, oval shape. A single, longitudinal strip 108 is illustrated in this view and is disposed inside of thru-aperture 106. Thin, burst membrane 105 is attached to top surface 107 of rectangular cap plate 102 and covers and seals thru-aperture 106.

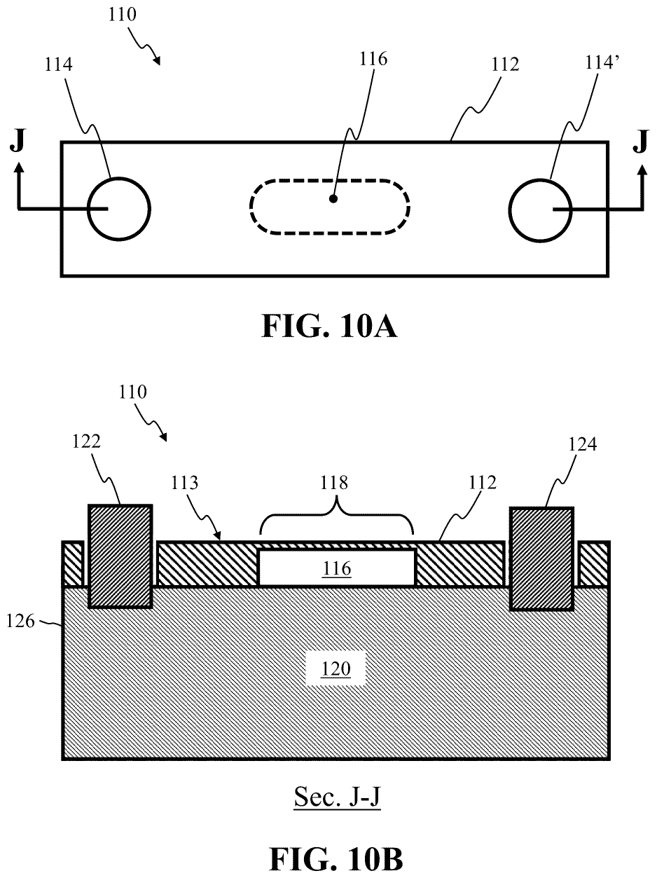

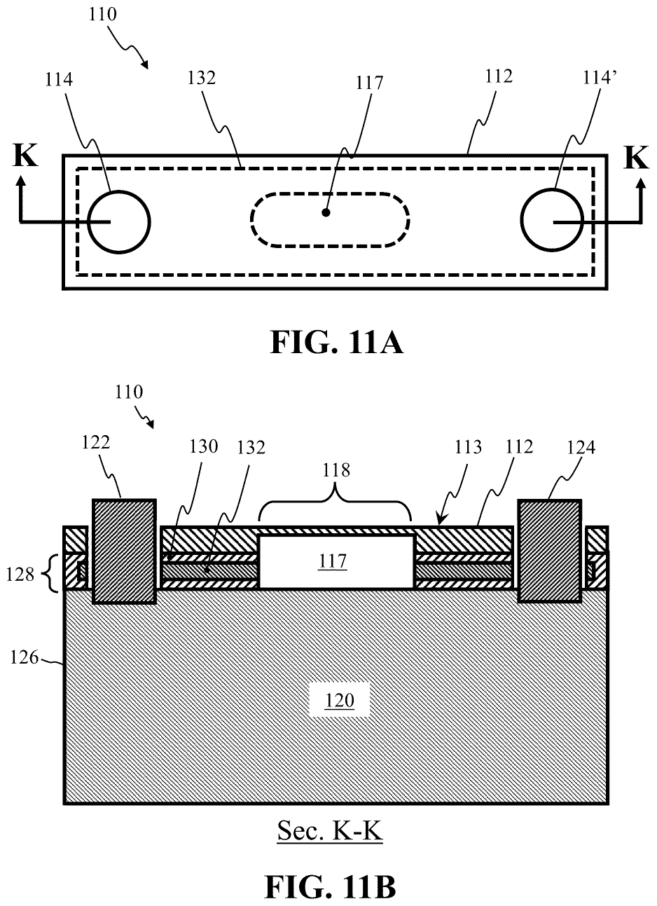

FIG. 10A shows a plan view of an example of an assembly 110 comprising a rectangular cap plate 112 disposed on top of a prismatic battery cell 120 that is enclosed within battery enclosure 126. Rectangular cap plate 112 comprises a pair of thru-holes 114 and 114′ disposed at opposite ends of rectangular cap plate 112. Rectangular cap plate 112 has a partially-recessed aperture 116, which may have an elongated, oval shape.

FIG. 10B shows an elevation, side cross-section view (Sec. J-J) of an example of an assembly 110 comprising a rectangular cap plate 112 disposed on top of battery cell 120. Battery cell 120 is enclosed within battery enclosure 126. Battery cell 120 comprises a first (e.g., anode) battery terminal 122 and a second (e.g., cathode) battery terminal 124, which pass through coaxially-aligned thru-holes 114 and 114′, respectively. Rectangular cap plate 112 defines partially-recessed aperture 116, which may have an elongated, oval shape. A thin, burst membrane layer 118 is made integrally with, and is flush with, top surface 113 of rectangular cap plate 112. Burst membrane layer 118 seals partially-recessed aperture 116.

FIG. 11A shows a plan view of an example of an assembly 110 comprising a rectangular cap plate 112 disposed above a thermal insulation plate 128 (not shown, see FIG. 11B) that is disposed on top of a battery cell 120 (not shown, see FIG. 11B). Rectangular cap plate 112 comprises a pair of thru-holes 114 and 114′ disposed at opposite ends of rectangular cap plate 112. Rectangular cap plate 112 defines partially-recessed aperture 117, which may have an elongated, oval shape. Thermal insulation layer 132 is disposed underneath rectangular cap plate 112.

FIG. 11B shows an elevation, side cross-section view (Sec. K-K) of an example of an assembly 110 comprising a rectangular cap plate 112 disposed above a thermal insulation plate 128 that is disposed on top of battery cell 120. Battery cell 120 is enclosed in battery enclosure 126. Battery cell 120 comprises an anode battery terminal 122 and a cathode battery terminal 124, which pass through coaxially-aligned thru-holes 114 and 114′, respectively. Rectangular cap plate 112 defines partially-recessed aperture 117, which may have an elongated, oval shape. Thermal insulation plate 128 comprises a “sandwich” construction comprising an inner thermal insulation layer 132 that is disposed inside of, and is encapsulated by, rectangular outer plate 130. Partially-recessed aperture 117 passes upwards through thermal insulation plate 128 and then is partially-recessed into rectangular plate 112. A thin, burst membrane layer 118 is made integrally with, and is flush with, top surface 113 of rectangular cap plate 112. Burst membrane layer 118 seals partially-recessed aperture 117.

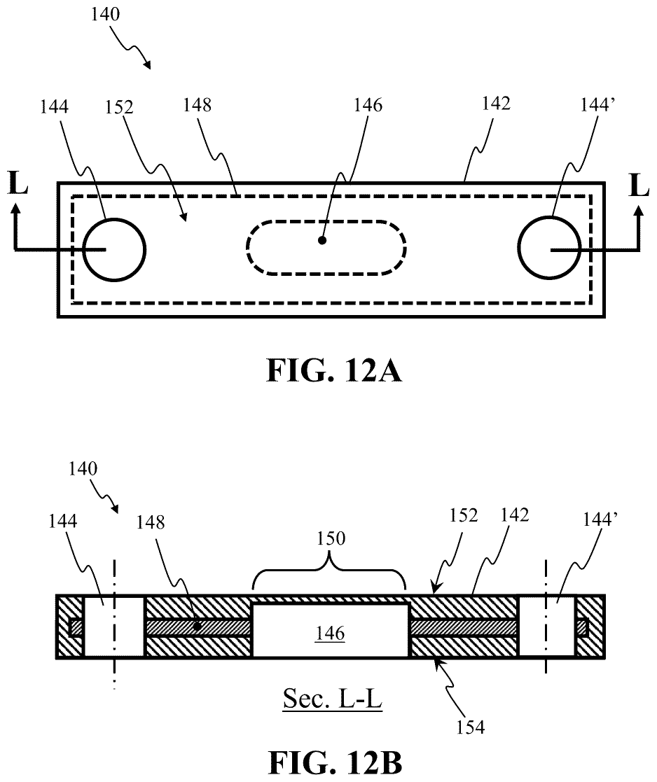

FIG. 12A shows a plan view of an example of a combined thermal protection plate 140 for use with a battery cell (not shown). Combined thermal protection plate 140 comprises a thick rectangular plate 142 with a pair of thru-holes 144 and 144′ disposed at opposite ends of rectangular cap plate 142. Thru-holes 144 and 144′ are oriented perpendicular to the top surface 152 of combined thermal protection plate 140. Thick rectangular cap plate 142 defines partially-recessed aperture 146, which may have an elongated, oval shape. Thermal insulation layer 148 is disposed inside of, and is encapsulated within, combined thermal protection plate 140.

FIG. 12B shows an elevation, side cross-section view (Sec. L-L) of an example of a combined thermal protection plate 140 for use with a battery cell (not shown). Partially-recessed aperture 146 is inserted upwards into a bottom surface 154 of thick rectangular plate 140. A burst membrane layer 150 is made integrally with, and is flush with, top surface 152 of thick rectangular plate 40. Burst membrane layer 150 seals partially-recessed aperture 146. Combined thermal protection plate 140 comprises a “sandwich” construction comprising an inner thermal insulation layer 148 that is disposed inside of, and is encapsulated by, thick rectangular plate 142. Partially-recessed aperture 146 is disposed through thermal insulation layer 148 and then is partially-recessed into thick rectangular plate 140.

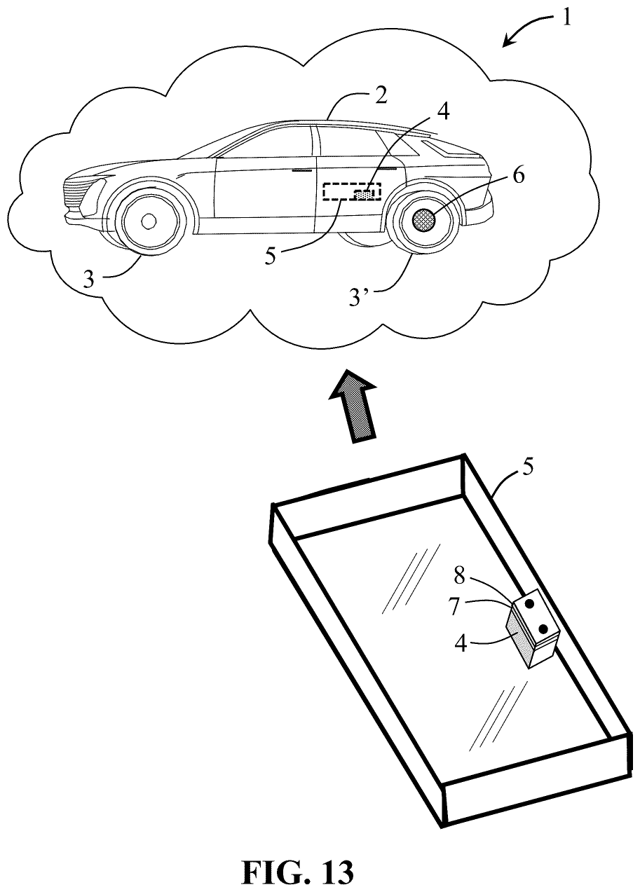

FIG. 13 shows a perspective view of an example of an automobile 1 with a battery tray 5 containing at least one battery cell 4. Automobile 1 comprises at least two wheels 3 and 3′, attached to a vehicle body 2. Battery cell 4 is electrically connected to at least one electric traction drive motor 6 configured to drive the two or more wheels 3 and 3'. Battery cell 4 comprises a cap plate 8 covering a top surface (not seen) of battery cell 4, and a thermal insulation plate 7 is disposed in-between cap plate 8 and above battery cell 4.

In some embodiments, a “perforated” cap plate may be used, which may comprise a regularly-oriented or a randomly-oriented array of multiple, small holes (diameter=1-3 mm) that are disposed through the cap plate in the area defined (i.e., bounded) by the thru-aperture that passes through the cap plate.

In other embodiments, a perforated cap plate may alternatively, or additionally, comprise a rectangular screen, a square screen, an elongated-oval screen, or a mesh insert that is disposed inside of the thru-aperture passing through a cap plate.

In some embodiments the thermal insulation layer may comprise a porous ceramic material (e.g., alumina (Al₂O₃)), with a porosity greater than about 10 % by volume.

In some embodiments, the outer plate comprises polyethylene or polyurethane.

In some embodiments, the burst membrane may have a thickness ranging from about 200 microns to about 500 microns.

In some embodiments, the burst pressure of the burst membrane may be specific to the battery cell dimensions, chemistry, and design. One design rule that may be used is that the burst pressure should be: (a) high enough so that the burst membrane doesn't rupture during normal gas generation through battery cell aging, and (b) low enough to make sure that it opens in any abnormal event that generates a high gas pressure inside of the battery cell.

In some embodiments, the thermal insulation layer may comprise an insulative material with a melting point greater than the combustion temperature of the battery cell chemistry. Examples include: (a) low energy density chemistries with combustion temperatures around 400 C, or (B) high energy density chemistries with combustion temperatures up to 1500 C (or moderate NMC (Nickel-Manganese-Cobalt) example of around 1000 C), such as lithium-metal batteries.

The detailed description and the drawings or figures contained herein are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. All embodiments and examples disclosed herein are non-limiting embodiments and non-limiting examples. The words: “a”, “an”, “the”, “at least one”, and “one or more” are used interchangeably to indicate that at least one of the specified items is present.

What is claimed is:

1. A thermal insulation plate, comprising:
an outer plate;
a thermal insulation layer that is encapsulated within the outer plate;
a first thru-hole that is disposed through the thermal insulation layer and the outer plate, wherein the first thru-hole is configured to accept a first battery terminal;
a second thru-hole that is disposed through the thermal insulation layer and the outer plate, wherein the second thru-hole is configured to accept a second battery terminal; and
a thru-aperture that passes through the thermal insulation layer and the outer plate; and
wherein the thru-aperture is configured to vent gases outwards from a battery cell in a controlled manner when a burst membrane on a cap plate covering a top of the battery cell has ruptured.

2. The thermal insulation plate of claim 1, wherein the thermal insulation layer comprises a thermal insulation material selected from the group consisting of a carbon fiber reinforced plastic composite (CFRP) material, mica, a steel alloy, a stainless-steel laminate, a ceramic material, an insulative material, an intumescent coating, and/or combinations thereof.

3. The thermal insulation plate of claim 2, wherein the intumescent coating is selected from the group consisting of Al₂O₃, ZrO₂, TiC, SiC, Si₃N₄, a porous ceramic material having at least 10% porosity by volume, a two-layer coating consisting of a metallic bond coat and ceramic top-coat, and steel coated with an epoxy-based intumescent paint, and/or combinations thereof.

4. The thermal insulation plate of claim 1, further comprising:
a top surface and a bottom surface of the outer plate; and
at least one recessed air gap recessed into the top surface and/or the bottom surface of the outer plate.

5. The thermal insulation plate of claim 4, wherein a thickness of the at least one recessed air gap ranges from about 25 microns to about 75 microns.

6. The thermal insulation plate of claim 1,
wherein the outer plate has a rectangular shape; and
wherein the thru-aperture has an elongated oval shape.

7. The thermal insulation plate of claim 1, wherein the outer plate comprises polyethylene.

8. A cap plate, comprising:
a rectangular plate;
a first aperture that is recessed into at least one side of the rectangular plate, comprising at least one opening in the rectangular plate;
a burst membrane covering the at least one opening in the rectangular plate;
a first thru-hole disposed through the rectangular plate, wherein the first thru-hole is configured to accept a first battery terminal; and
a second thru-hole disposed through the rectangular plate, wherein the second thru-hole is configured to accept a second battery terminal;
wherein the burst membrane covers the at least one opening in the rectangular plate; and
wherein the first aperture is configured to vent gases outwards from a battery cell in a controlled manner when the burst membrane has ruptured.

9. The cap plate of claim 8, wherein the first thru-hole and the second thru-hole are located at opposite ends of the rectangular plate.

10. The cap plate of claim 8,
wherein the rectangular plate has a long direction;
wherein the first aperture passes through the rectangular plate; and
wherein the rectangular plate comprises a plurality of parallel, uniformly spaced-apart strips disposed inside of the first aperture, which are oriented perpendicular to the long direction of the rectangular plate.

11. The cap plate of claim 8,
wherein the rectangular plate has a long direction;
wherein the first aperture passes through the rectangular plate; and
wherein the rectangular plate comprises a plurality of parallel, uniformly spaced-apart strips disposed inside of the first aperture, which are oriented parallel to the long direction of the rectangular plate.

12. The cap plate of claim 8, wherein the rectangular plate has a top surface;
wherein the burst membrane has a top surface;
wherein the burst membrane is an integral part of the rectangular plate; and
wherein the burst membrane is flush with the top surface of the rectangular plate.

13. The cap plate of claim 8,
wherein the rectangular plate has a top surface;
wherein the burst membrane has a top surface;
wherein the burst membrane is attached to the top surface of the rectangular plate; and
wherein the top surface of the burst membrane is not flush with the top surface of the rectangular plate.

14. The cap plate of claim 8,
wherein the rectangular plate has a bottom surface; and
wherein the rectangular plate comprises a pair of extruded, inwardly-facing, L-shaped, attachment hooks disposed underneath the bottom surface of the rectangular plate.

15. The cap plate of claim 14, further comprising:
a thermal insulation plate that is disposed underneath the cap plate, wherein the thermal insulation plate comprises:
an outer plate;
a thermal insulation layer that is encapsulated within the outer plate; and
a second aperture passing through the thermal insulation layer and the outer plate;
wherein the thermal insulation plate is disposed between, and is held by, the pair of extruded, inwardly-facing, L-shaped, attachment hooks.

16. The cap plate of claim 8,
wherein the rectangular plate comprises a bi-metallic laminate comprising:
a top layer made of a first metal; and
a bottom layer made of a second metal;
wherein the top layer is attached to the bottom layer; and
wherein the first metal is different than the second metal.

17. The cap plate of claim 8, further comprising:
a thermal insulation plate that is disposed underneath the cap plate, wherein the thermal insulation plate comprises:
an outer plate;
a thermal insulation layer that is encapsulated within the outer plate; and
a second thru-aperture passing through the thermal insulation layer and the outer plate; and
wherein the first aperture and the second thru-aperture are co-aligned with respect to each other.

18. The cap plate of claim 17,
further comprising a prismatic battery cell;
wherein the cap plate is disposed on top of the prismatic battery cell; and
wherein the thermal insulation plate is disposed in-between the cap plate and the prismatic battery cell.

19. A vehicle, comprising:
(a) a vehicle body;
(b) at least one wheel attached to the vehicle body;
(c) at least one electric traction drive motor configured to drive the at least one wheel;
(d) a prismatic battery cell, which is electrically connected to the at least one electric traction drive motor, comprising:
a first terminal disposed at a proximal end of the prismatic battery cell; and
a second terminal disposed at a distal end of the prismatic battery cell
(e) a cap plate, disposed above the battery cell, comprising:
a rectangular plate;
a first aperture that is recessed into at least one side of the rectangular plate, comprising at least one opening in the rectangular plate;
a burst membrane covering the at least one opening;
a first thru-hole disposed through the rectangular plate, wherein the first thru-hole is configured to accept the first battery terminal;
a second thru-hole disposed through the rectangular plate, wherein the second thru-hole is configured to accept the second battery terminal;
wherein the burst membrane covers the at least one open side of the first aperture; and
wherein the first aperture is configured to vent gases outwards from the battery cell in a controlled manner when the burst membrane is ruptured;
(f) a thermal insulation plate, disposed underneath the cap plate and above the battery cell, comprising:
an outer plate;
a thermal insulation layer that is encapsulated within the outer plate;
a third thru-hole disposed through the thermal insulation layer and the outer plate at a proximal end of the thermal insulation plate;
a fourth thru-hole disposed through the thermal insulation layer and the outer plate at a distal end of the thermal insulation plate; and
a second thru-aperture passing through the thermal insulation layer and the outer plate;
wherein the first thru-hole and the third thru-hole are coaxially aligned with the first terminal;
wherein the second thru-hole and the fourth thru-hole are coaxially aligned with the second terminal; and
wherein the first aperture and the second thru-aperture are coaxially aligned with respect to each other.

20. The vehicle of claim 19,
further comprising a first rivet disposed through:
(1) the first terminal;
(2) the first thru-hole; and
(3) the third thru-hole; and
further comprising a second rivet disposed through:
(4) the second terminal;
(5) the second thru-hole; and
(6) the fourth thru-hole; and
wherein the first rivet and the second rivet are configured for attaching the cap plate and the thermal insulation plate to the battery cell.
